(19) United States
(12) Patent Application Publication
(10) Pub. No.: US 2026/0141642 A1
(43) Pub. Date: May 21, 2026

(54) VEHICLE-CENTERED VIRTUAL ENVIRONMENT EXPERIENCE

(71) Applicant: International Business Machines Corporation, Armonk, NY (US)

(72) Inventors: Guang Han Sui, Beijing (CN); Peng Hui Jiang, Beijing (CN); Jun Su, Beijing (CN); Yu Zhu, Beijing (CN); Jun Feng Duan, Beijing (CN)

(21) Appl. No.: 18/952,074

(22) Filed: Nov. 19, 2024

(51) Int. Cl. G06T 19/00

(52) U.S. Cl. CPC G06T 19/00; G06T 2200/24

(57) ABSTRACT

Techniques are described with respect to a system, method, and computer program product for generating vehicular-based visualizations. An associated method includes receiving a plurality of vehicular parameters associated with a vehicle; analyzing the plurality of vehicular parameters based on a user profile associated with at least one occupant of the vehicle; and generating a virtual environment visualization associated with the vehicle based on the analysis.

### BACKGROUND

This disclosure relates generally to the field of optimized virtual experiences, and more particularly to utilizing artificial intelligence mechanisms to analyze vehicular parameters and generate vehicular-based virtual experiences based on the analyses.

The vehicular experience, whether as an operator or a passenger, can be plagued with various encumbrances including, but not limited to traffic/road conditions, weather conditions, detours/obstacles, and the like. Vehicles have increasingly gained capabilities that allow in-vehicle virtual visualizations, in which virtual reality (VR), augmented reality (AR), mixed reality (MR), and/or extended reality (XR) systems are able to be integrated into the applicable displays of the vehicle for informative and/or entertainment purposes.

### SUMMARY

Additional aspects and/or advantages will be set forth in part in the description which follows and, in part, will be apparent from the description, or may be learned by practice of the invention.

A system, method, and computer program product for generating vehicular-based visualizations is disclosed herein. In some embodiments, a computer-implemented method for generating vehicular-based visualizations comprises receiving a plurality of vehicular parameters associated with a vehicle; analyzing the plurality of vehicular parameters based on a user profile associated with at least one occupant of the vehicle; and generating a virtual environment visualization associated with the vehicle based on the analysis.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a vehicle visualizations management system environment, according to an exemplary embodiment;

FIG. 3 illustrates a block diagram of various modules associated with the vehicle visualization management system of FIG. 2, according to an exemplary embodiment;

FIG. 4 illustrates a vehicle with predicted vehicle parameters, according to an exemplary embodiment;

FIG. 5 illustrates two occupants in the vehicle of FIG. 4 donning computer-mediated reality devices depicting vehicle visualizations, according to an exemplary embodiment;

FIG. 6 illustrates a first vehicular-based visualization rendered based on a first vehicle parameter of the predicted vehicle parameters of FIG. 4, according to an exemplary embodiment;

FIG. 7 illustrates a vehicular-based visualization rendered based on a second vehicle parameter and a third vehicle of the predicted vehicle parameters of FIG. 4, according to an exemplary embodiment; and

FIG. 8 illustrates an exemplary flowchart depicting a method for generating vehicular-based visualizations, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Aspects of an embodiment of the present invention disclose a method, system, and computer program product for generating vehicular-based visualizations. In some embodiments, a computer-implemented method for generating vehicular-based visualizations comprises receiving a plurality of vehicular parameters associated with a vehicle; analyzing the plurality of vehicular parameters based on a user profile associated with at least one occupant of the vehicle; and generating a virtual environment visualization associated with the vehicle based on the analysis.

In various aspects, the invention relates to a computer program product for generating vehicular-based visualizations, the computer program product comprising or more computer readable storage media and program instructions collectively stored on the one or more computer readable storage media, the stored program instructions comprising: program instructions to generate vehicular-based visualizations comprises receiving a plurality of vehicular parameters associated with a vehicle; program instructions to analyze the plurality of vehicular parameters based on a user profile associated with at least one occupant of the vehicle; and program instructions to generate a virtual environment visualization associated with the vehicle based on the analysis.

In another aspect, the invention relates to a computer system for generating vehicular-based visualizations, the computer system comprising: one or more processors; one or more computer-readable memories; program instructions stored on at least one of the one or more computer-readable memories for execution by at least one of the one or more processors, the program instructions comprising program instructions to generate vehicular-based visualizations comprises receiving a plurality of vehicular parameters associated with a vehicle; program instructions to analyze the plurality of vehicular parameters based on a user profile associated with at least one occupant of the vehicle; and program instructions to generate a virtual environment visualization associated with the vehicle based on the analysis.

In various aspects, analyzing the plurality of vehicular parameters further comprises analyzing a plurality of contextual information associated with the at least one occupant; analyzing a plurality of feedback information associated with the virtual environment visualization and the at least one occupant; and updating the user profile based on the plurality of feedback information. As a result, illustrative embodiments provide a technical effect of optimizing visualizations for vehicle occupants reflecting preferences, occupant feedback, and other applicable factors, in which each occupant may receive and view a distinct and personalized visualization tailored to the aforementioned.

In various aspects, generating the virtual environment visualization comprises utilizing one or more machine learning models to generate one or more predictions associated with a vehicular experience based on the plurality of vehicular parameters; and integrating a plurality of virtual elements derived from the one or more predictions into the virtual environment visualization. As a result, illustrative embodiments provide a technical effect of generating visualizations derived from predictions associated with vehicle parameters and/or road conditions, in which vehicle parameters and/or road conditions are correlated to the user profile and interactive digital elements are integrated/updated into the visualizations for real-time interaction with occupants.

The following described exemplary embodiments provide a method, computer system, and computer program product for generating vehicular-based visualizations. Vehicles now having functionality to detect various obstacles associated with routes not only allows optimized driving decisions, but also supports predictions relating to road and weather conditions that are otherwise considered a nuisance for vehicle operators and/or occupants. Furthermore, VR, AR, MR, and/or XR technologies provide a real-time view of a physical, real-world environment whose elements are augmented with computer-generated virtual elements for integration into visualizations displayed on applicable computing devices such as, but not limited to computer-mediated reality devices. These visualizations may serve as a form of entertainment for vehicle occupants, in which occupants may view an enhanced environment comprising overlaid graphics, text, sound, etc. associated with current road conditions and/or predicted road conditions. Therefore, the present embodiments have the capacity to provide a system that not only generates visualizations based on road conditions and/or vehicle occupants, but also utilize artificial intelligence techniques to generate visualizations based on predictions associated with factors including, but not limited to road conditions, vehicle parameters, user profiles associated with occupants, and the like. In addition, the present embodiments further have the capacity to update and optimize visualizations based on contextual information ascertained from outputs of one or more machine learning environments resulting in user/vehicle-specific visualizations for occupants to experience while the vehicle is in operation.

As described here, the term “visualization” comprises one or more video, images, text, audio, holograms, etc., or combination thereof generated and depicted to a vehicle operator and/or occupants. In particular, the visualizations are illustrated in virtual environments allowing real-time viewing of a physical, real-world environment comprising elements augmented with computer-generated virtual elements.

As described here, the term “vehicle parameters” comprises one or more internal and/or external features associated with a vehicle (e.g., car, plane, etc.) including, but not limited to vehicle parts (e.g., displays, tires, etc.), vehicle features (e.g., air conditioning, seat warmers, etc.), and the like. Vehicle parameters may further comprise road conditions (e.g., traffic, accidents, potholes, etc.), weather conditions, and the like associated with routes traversed and/or expected to be traversed by the vehicle.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

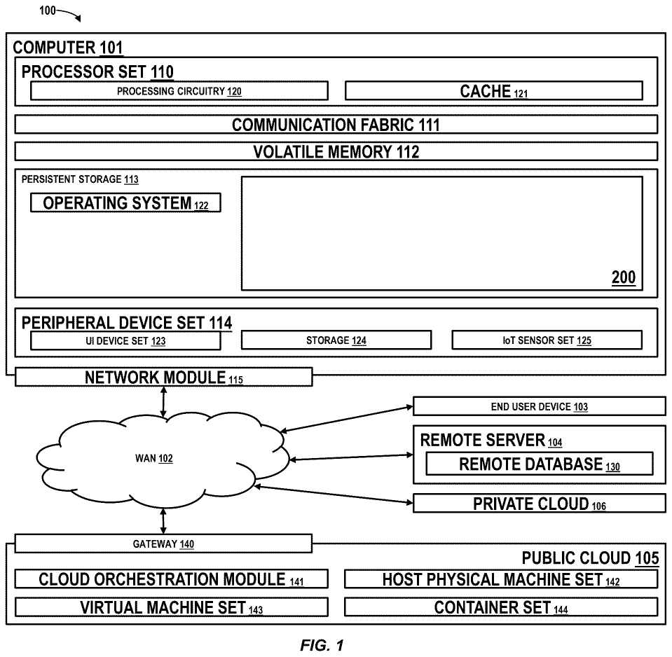

The following described exemplary embodiments provide a system, method, and computer program product for optimizing a virtual avatar. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

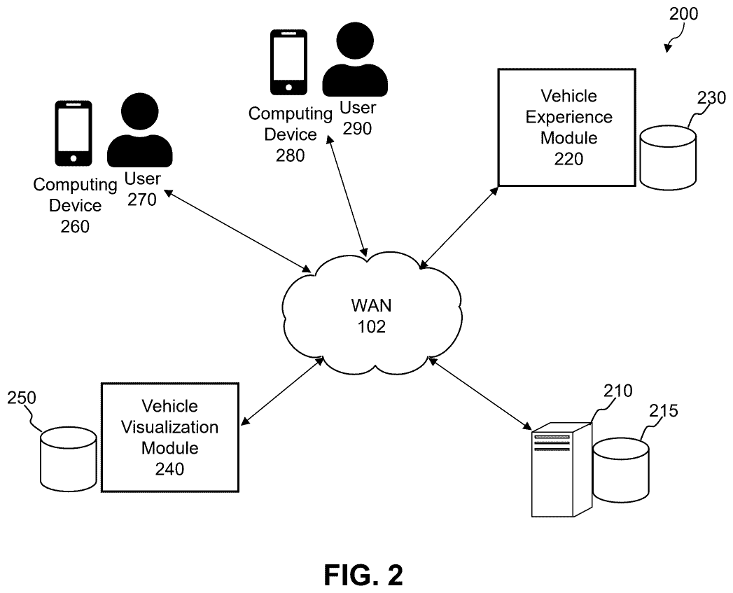

Referring now to FIG. 2, a functional block diagram of a networked computer environment illustrating a computing environment for a vehicle visualizations management system 200 (hereinafter “system”) comprising a server 210 communicatively coupled to a database 215, a vehicle experience module 220 communicatively coupled to a vehicle experience module database 230, a vehicle visualization module 240 communicatively coupled to a vehicle visualization module database 250, a first computing device 260 associated with a second user 270, and a second computing device 280 associated with a second user 290, each of which are communicatively coupled over WAN 102 (hereinafter “network”) and data from the components of system 200 transmitted across the network is stored in database 215. It should be noted that computing devices 260 and 280 may be a system integrated and/or associated with a vehicle-based system comprising a vehicle and/or a vehicle monitoring system (e.g., computer vision system, Closed Circuit Television system, and the like). For example, computing devices 260 and 280 may be communicatively coupled to the vehicle-based system comprising one or more sensors configured to receive sensor data associated with internal and external elements of a vehicle and/or users 270 and 290 for analyses by vehicle experience module 220 and/or vehicle visualization module 240. Examples of sensor data collected by the one or more sensors may include, but is not limited to image data, video data, audio data, LIDAR data, LADAR data, occupant(s) movement-related data, air quality data, ventilation-based data, steering data, trip data, vehicular communication with other applicable computing devices (e.g., RFID, security systems, thermal-based systems, etc.) and/or other applicable ascertainable data associated with the vehicular environment known to those of ordinary skill in the art.

Vehicle experience module 220 is tasked with collecting, analyzing, and aggregating vehicular related information associated with the maintenance, operation, and traversing of the applicable vehicle associated with computing devices 260 and 280. Furthermore, vehicle experience module 220 is configured to analyze the vehicular related information based on contextual information and one or more factors ascertained from user profiles associated with vehicle occupants and/or operator(s). For example, the vehicle experience may consist of the vehicle traversing various routes, obstacles, terrains, etc. traditionally resulting in vehicle operator/occupants being exposed to various traffic, weather, detours, road conditions, and the like; however, vehicle experience module 220 takes into consideration various information associated with the vehicle and the operator/occupants such as, but not limited to geographic location, terrain, occupant preferences related to vehicle conditions, visualizations (e.g., no strobing/flashing objects, etc.), and the like. In addition, vehicle experience module 220 is configured to ascertain contextual information associated with the vehicle in order to ascertain factors relevant for the subsequent generation of the visualizations in the vehicle such as, but not limited to geographic location, weather, road conditions, current events, and the like. Furthermore, vehicle experience module 220 is configured to generate and maintain user profiles associated with occupants of the vehicle for the purpose of analyzing the user profiles in order for vehicle visualization module 240 to ultimately generate and tailor personalized visualizations for users 270 and 290 based on their respective user profiles. For example although users 270 and 290 may be in the same vehicle experiencing the same road conditions, the visualizations generated and presented to computing devices 260 and 280 may be completely different due to the fact that the visualizations may be rendered taking into consideration the respective user profiles. In some embodiments, user profiles may be generated based on information stored in vehicle experience module database 230, in which one or more crawlers associated with server 210 may ascertain relevant data associated with users 270 and 290 from various data sources such as, but not limited to social networking sites, blog sites, and any other applicable internet-based data sources known to those of ordinary skill in the art.

Vehicle visualization module 240 is tasked with generating the personalized visualizations associated with the vehicle in addition to optimizing the visualizations based on feedback derived from users 270 and 290. It should be noted that the visualizations may comprise one or more virtual elements depicted within a virtual environment in which the virtual elements may receive interactions from users 270 and 290 (e.g., gestures, voice-based commands, head movements, eye movements, etc.). In some embodiments, one or more virtual elements may be derived from vehicle visualization module 240 performing correlations among the vehicle parameters and one or more components of the user profiles. For example, the vehicle may be experiencing and/or expecting to experience rain during traversal of a route, in which one or more factors derived from analyses of the user profile may be integrated into one or more virtual elements depicted within the applicable generated visualization (e.g., trivia questions integrated into raindrops configured to receive user interactions, etc.). Furthermore, vehicle visualization module 240 operates a feedback loop associated with the visualizations in order to optimize the presentation of future visualizations for users 270 and 290. User profiles may also be updated based on the feedback loop. In some embodiments, computing devices 260 and 280 may collect brainwave signals of users 270 and 290 allowing vehicle visualization module 240 to perform analyses and classifications of brainwave signals with proper consent given by users 270 and 290. As a result, pertinent signal characteristics (i.e., signal features relating to a person's intent and/or emotions) are distinguished from extraneous content and the analyzed signals are represented in a compact form that may be suitable for translation into an output capable of being received and/or understood by vehicle visualization module 240; therefore not only supporting identification of the range of where users 270 and 290 and the vehicle will move, but also supporting predictions of a movement path of the aforementioned. Vehicle visualization module 240 may store the visualizations and the optimizations thereof in vehicle visualization module database 250 for scalable access without utilizing unnecessary computing resources.

Computing devices 260 and 280 may take the form of a desktop computer, laptop computer, tablet computer, computer-mediated reality device (CMR), smart phone, smart watch or other wearable computer, mainframe computer, vehicle network-based computing device, vehicle to vehicle network system, quantum computer or any other form of computer or mobile device now known or to be developed in the future that is capable of running a program, accessing a network or querying a database. In some embodiments, computing devices 260 and 280 are communicatively coupled to a vehicular computer system comprising one or more of a display system and an embedded subscriber identification module (eSIM), configured to communicate with other vehicles in order to ascertain contextual information, and transmit information derived from vehicle experience module 220 and/or vehicle visualization module 240 to users 270 and 290 on their respective computing device(s).

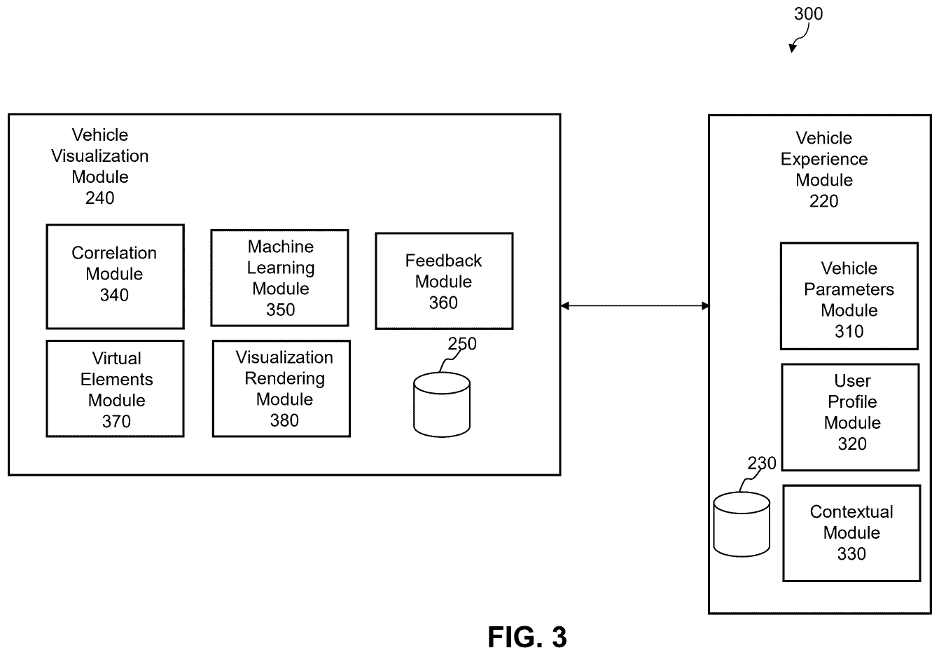

Referring now to FIG. 3, an example architecture 300 of vehicle experience module 220 and vehicle visualization module 240 is depicted, according to an exemplary embodiment. In some embodiments, vehicle experience module 220 comprises vehicle parameters module 310, user profile module 320, and contextual module 330. Vehicle visualization module 240 comprises correlation module 340, machine learning module 350, feedback module 360, virtual elements module 370, and visualization rendering module 380. It should be noted that vehicle experience module 220 and vehicle visualization module 240 are communicatively coupled over the network allowing for outputs and/or analyses performed by each respective module to be utilized in applicable training datasets to be utilized by applicable machine learning models operated by machine learning module 350 and/or applicable cognitive systems associated with system 200. Vehicle visualization module 240 ascertains informed consent, with notice of the collection of personal and/or confidential company data, allowing the user to opt in or opt out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Vehicle visualization module 240 may provide information regarding personal and/or confidential company data and the nature (e.g., type, scope, purpose, duration, etc.) of the processing. Vehicle visualization module 240 may further provide the user with copies of stored personal and/or confidential company data, and allows the correction or completion of incorrect or incomplete personal and/or confidential company data. Furthermore, vehicle visualization module 240 allows for the immediate deletion of personal and/or confidential company data.

Vehicle parameters module 310 is tasked with collecting and receiving internal and/or external vehicle parameters pertaining to the applicable vehicle associated with computing devices 260 and 280. In some embodiments, vehicle parameters may be ascertained based on the aforementioned sensor data allowing information associated with the vehicular experience such as, but not limited to projected route for the vehicle to traverse, air quality, internal vehicle temperature, engine analytics (e.g., compression ratio, swept volume, power output, etc.), fuel efficiency, battery performance, acceleration data, brake thermal efficiency, aerodynamics, transmission, ride comfort, speed analytics, handling characteristics, or any other applicable vehicle performance and/or vehicular environment related information known to those of ordinary skill in the art. Vehicle parameters may further account for identification-related data associated with the vehicle including, but not limited to vehicle identification number (“VIN”), license plate number, and the like. In some embodiments, vehicle parameters account for conditions the vehicle is sustaining in real-time, in which virtual environments and virtual elements may be rendered based on said conditions. For example, if the vehicle is traveling along a bumpy road causing the vehicle to shake then a virtual environment comprising a ship in a choppy ocean may be generated. Furthermore, vehicle parameters module 310 communicates with machine learning module 350 in order to operate one or more machine learning models configured to generate outputs representing predictions associated with the applicable vehicle. The one or more machine learning models may generate predictions associated with the route to be traversed by the vehicle based on one or more of the geographic location, local events, weather forecast, road conditions, and any other applicable information known to those of ordinary skill in the art. As a result of the aforementioned, vehicle parameters related to the vehicle may be predicted and subsequently correlated to components of the user profile for the purpose of rendering virtual elements to be integrated into visualizations presented to computing devices 260 and 280. For example, an output of the one or more machine learning models may indicate that the weather in the relevant geographic location that the vehicle will be traveling within will be cold, in which a vehicle parameter-related prediction indicates the internal temperature of the vehicle will be warm. If it is able to be ascertained from the user profile associated with user 270 that they dislike warm temperatures then visualization rendering module 380 ultimately generates a virtual environment depicting an inferno with virtual elements impacted by the inferno for presentation to computing device 260.

User profile module 320 is tasked with generating and managing user profiles associated with users 270 and 290 who are occupants of the applicable vehicle. In some embodiments, user profiles may comprise data ascertained from one or more of server 210, computing devices 260 and 280, vehicle experience module database 230, and vehicle visualization module database 250. For example, the user profiles may comprise data relating to internet browsing/social media activity, preferences of users 270 and 290, interests, and the like. Furthermore, analytics associated with users 270 and 290 may be included in the user profiles such as, but not limited to biological data (e.g., heartrate, user positioning, eye tracking, heart rate, brain activity data/brainwave signals, facial reactions/electromyography-related data, and the like), user engagement data associated with visualizations/virtual environments/virtual elements, and any other applicable ascertainable information associated with user engagement known to those of ordinary skill in the art. Furthermore, user profile module 320 communicates with feedback module 360 in order to ascertain feedback relating to users 270 and 290 with received visualizations for the purpose of integrating said feedback into the respective user profiles. For example, feedback module 360 may record user interactions (e.g., eye gazing analytics, facial reactions, brainwave signals) with a given visualization in order for feedback module 360 to make determinations relating to users 270 and 290 and transmit said determinations to user profile module 320 for integration into the user profiles.

Contextual module 330 is tasked with ascertaining contextual information associated with the vehicle and/or users 270 and 290. Contextual information may account for geographic location, road conditions, inclement weather, route detours, obstructions (e.g., non-moving vehicle, animals on the road, etc.), fuel level/car-battery level, sentiments of vehicle occupants, marketing material along a route, and the like. In some embodiments, contextual information may also account for operation modes associated with the vehicle such as, but not limited to whether the vehicle is in a manual mode requiring a human operator to do all the driving, an advanced driver assistance mode where the operator supports steering/accelerating/braking, full autonomous driving supported by wireless communication technologies (e.g., vehicle-to-vehicle, 5G, etc.), and the like. Operation modes may be critical to contextual determinations made by contextual module 330 due to the fact vehicle parameters have the capacity to be impacted by the current operation mode that the vehicle is in. For example, if there is a detour causing a significant delay detected ahead in the route being traversed by the vehicle, then the operation mode of the vehicle may switch from a first mode to a second mode based on the contextual information resulting in triggering of visualizations being rendered for vehicle occupants. In another example, if the vehicle operator is not able to safely drive the vehicle then contextual information will be utilized to provide a solution to predict what type of driving scenario will be upcoming and proactively switch the operation mode of the vehicle triggering rendering of visualizations that integrate the vehicle and/or subsets into a virtual environment for the operator to enjoy when the vehicle is not being manually driven.

Correlation module 340 is tasked with correlating components of the ascertained contextual information and user profiles. In particular, correlation module 340 performs processing of vehicle parameters, user profiles, sensor data collected from computing devices 260 and 280, and the like to identify correlations with the ascertained contextual information. Correlation methods may include any suitable correlation processing method such as k Nearest Neighbor, k-Means, Apriori Algorithm, and the like. In some embodiments, the correlations may support predictions generated by the one or more machine learning models operated by machine learning module 350. For example, one or more established correlations between the vehicles parameters and the user profile associated with user 270 may result in the one or more machine learning models predicting a relevant virtual environment, virtual elements (e.g., themes, virtual objects, setting, avatar appearances, etc.), and the like for the visualizations presented to computing device 260. In another example, correlations ascertained from the user profile and the contextual information result in the applicable visualization presented to computing device 260 comprising an augmented reality-based game involving the vehicle based on the predicted route for the vehicle indicating a long amount of time in the vehicle. In some embodiments, vehicle parameters having strong correlations with intent of users 270 and 290 when compared to the user profiles may by classified by correlation module 340 in order to distinguish whether brainwave signals and/or other applicable sensor data collected by computing devices 260 and 280 is directed towards a vehicle parameter and/or visualization. For example, brainwave signals and/or sensor data may indicate that user 270 has a dislike for a vehicle parameter (e.g., road obstruction, lightening/thunder, etc.) resulting in a visualization being rendered that removes the disliked vehicle parameter. Simultaneously, irrelevant brainwave signals, sensor data, and/or vehicle parameters may be filtered out and the classified vehicle parameters may be utilized by virtual elements module 380 for rendering relevant virtual elements ultimately included in visualizations presented to occupants.

Machine learning module 350 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. For example, machine learning module 350 is designed to maintain one or more machine learning models dealing with training datasets including data derived from database 215, vehicle experience module database 230, and vehicle visualization module database 250, in which the one or more machine learning models generate outputs representing predictions relating to contextual information, vehicle parameters, vehicle operation mode, user engagement analytics (e.g., user interactions with visualizations, etc.), virtual elements integrated into visualizations, and the like.

Feedback module 360 is designed to ascertain feedback of users 270 and 290 associated with respective visualizations presented to computing devices 260 and 280. In some embodiments, feedback module 360 communicates with machine learning module 350 to analyze feedback to train or update the one or more machine learning models to identify preferences of occupants in order to optimize subsequent generated visualizations. In addition, feedback module 360 may be utilized to improve vehicle parameters, contextual information, and the like. Feedback module 360 may also account for sensory feedback mechanisms derived from sensor data and brainwave signals collected by computing devices 260 and 280. It should be noted that feedback module 360 may be communicatively coupled to a brain-communication interface system in order to effectively interpret brainwave signals for the purpose of optimizing visualizations presented to users 270 and 290. Furthermore, feedback module 360 may be utilized to determine trigger events that initiate generation of visualizations based one or more of contextual information, vehicle parameters, user profiles, and the like. For example, visualizations may be generated upon the vehicle transitioning into a fully autonomous mode allowing the vehicle and one or more vehicle parameters to be integrated into a virtual environment for the operator to experience without completely distracting the operator from the road. For example, the user profile associated with user 270 may indicate that they enjoy rollercoasters, in which detected upcoming road conditions automatically transition the vehicle into fully automatic mode and visualization rendering module 380 renders a virtual environment reflecting a virtual roller coaster experience in which the vehicle mimics a roller coaster train within a virtual roller coaster experience. Based on feedback module 360 utilizing the aforementioned methods to analyze reactions of user 270 to the virtual roller coaster experience (e.g., frequent squinting of the eyes, increased heart rate, etc.), feedback module 360 instructs visualization rendering module 380 to modify the current visualization by decreasing the brightness, slowing down the movements of the visualization, and the like.

Virtual elements module 370 is tasked with generating virtual elements for integration into visualizations rendered by visualization rendering module 380. In some embodiments, the one or more machine learning models generate outputs representing predictions associated with a vehicular experience based on the one or more vehicle parameters, in which virtual elements derived from the predictions are integrated into the virtual environment visualization. In some embodiments, virtual elements module 370 leverages vehicle parameters derived from collected sensor data in order to determine which virtual elements will be selected and integrated into a given visualization based on the respective user profiles. The visualizations are overlays perceived by user 270 and user 290 donning computing devices 260 and 280 through vehicle components such as but not limited to vehicle windows, mirrors, windshield, etc. It should be noted that the generation of virtual elements may be based on one or more of vehicle parameters, contextual information, user profiles, feedback module 360, previous correlations, and the like and may comprise but is not limited to virtual assistants, avatars, virtual environment themes, interactive virtual objects configured to receive at least one input (e.g., speech input, text input, AR/VR gestures, etc.), AR/VR prompts, and any other applicable digital elements known to those of ordinary skill in the art. For example, correlations between derivatives of the user profile and one more vehicle parameters may result in a first set of virtual elements being selected that are tailored towards user 270 and a second set of virtual elements being selected that are tailored towards user 290. Virtual elements may further include, but are not limited to a series of animations, games, interactive stories, text displays, audio, and any other applicable VR/AR based interactions known to those of ordinary skill in the art triggered by one or more user interactions with the visualization. For example, the visualization is a three-dimensional virtual environment comprising one or more virtual objects configured to receive one or more inputs (e.g., virtual reality-based gestures, speech input, hand motions, eye gazing, etc.) from user 270 and user 290 which triggers one or more interactive experiences. The visualization integrates the one or more vehicle parameters resulting in the vehicle being immersed in a virtual environment, in which the visualization may dramatized animations representing driving actions performed by the vehicle. For example, in autonomous pilot mode the visualization may depict to user 270 via computing device 260 the vehicle steering wheel as the helm of a ship, in which upon the turning of the vehicle may result in the visualization comprising a dramatized animation of the ship in a virtual environment traversing rocky waters. Concurrently, in autonomous pilot mode the visualization may depict to user 290 via computing device 280 the vehicle steering wheel as the cockpit of a plane or spaceship.

Visualization rendering module 380 is tasked with rendering personalized visualizations that integrate both the applicable vehicle and aforementioned virtual elements. In some embodiments, visualization rendering module 380 communicates with machine learning module 350 in order to utilize one or more generative adversarial networks (GANs) to render the visualizations in a manner that allows the vehicle to become a component of the visualization. Visualization rendering module 380 may take into consideration various factors such as, but not limited to contextual information, vicinity of other vehicles, weather conditions that impact visibility, driving events, and the like when rendering the visualizations. Furthermore, visualization rendering module 380 may utilize one or more trained learning machine learning models to predict the optimal location within the vehicle for each of user 270 and user 290 to depict visualizations. The predicted optimal location for display may also take into consideration predicted movements of the applicable vehicle based upon on one or more of the vehicle parameters.

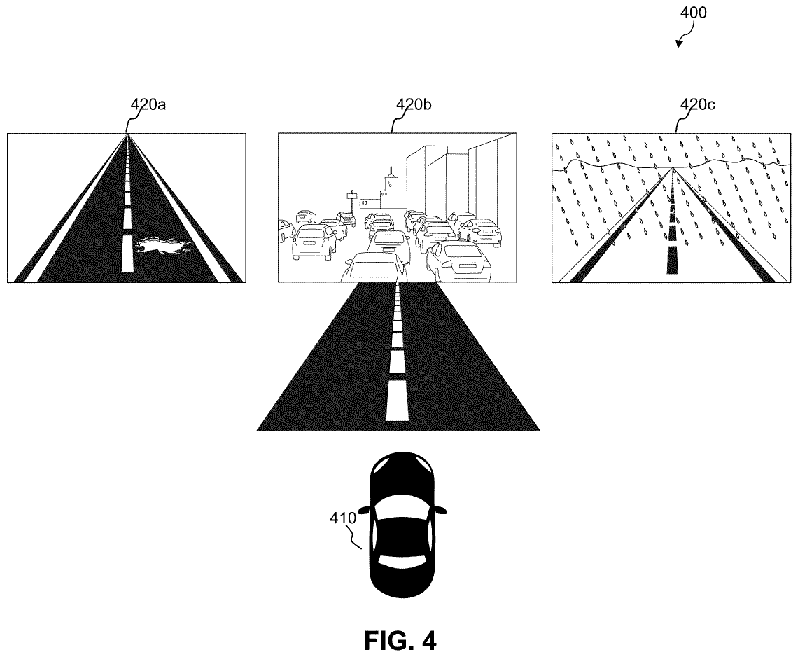

Referring now to FIG. 4, a vehicle scenario 400 with predicted vehicle parameters 420a-c associated with a vehicle 410, according to an exemplary embodiment. In this particular example, vehicle parameter 420a represents a potential pothole along the projected route associated with vehicle 410, vehicle parameter 420b represents a predicted traffic associated with a route vehicle 410 will traverse, and vehicle parameter 420a represents potential weather vehicle vehicle 410 will be exposed to, and vehicle parameter 420c represents predicted weather associated with a predicted route that vehicle 410 will traverse. In some embodiments, vehicle parameters 420a-c are ascertained from sensor data associated with internal and external elements of a vehicle 410. Vehicle parameters 420a-c may also be derived from monitoring systems, closed-circuit television (CCTV) systems, computer vision system, Internet-Of-Things (IOT) sensor systems, Department of Motor Vehicles (DMV) databases, applicable entities qualified under Federal Driver's Privacy Protection Act (DPPA), and the like. Vehicle parameters 420a-c may also account for external input data (e.g., road conditions, air conditions, visibility, weather, light, etc.). In some embodiments, vehicle parameters 420a-c are determined based on contextual information such as, but not limited to identified objects/animals on the roadway, limited visibility, smoke from a forest fire, operation modes (e.g., autonomous mode, advanced driver assistance mode, etc.), etc. It should be noted that the vehicle parameters are configured to be dynamically updated based on one or more newly acquired sensor data, contextual information, the user profiles, and the like.

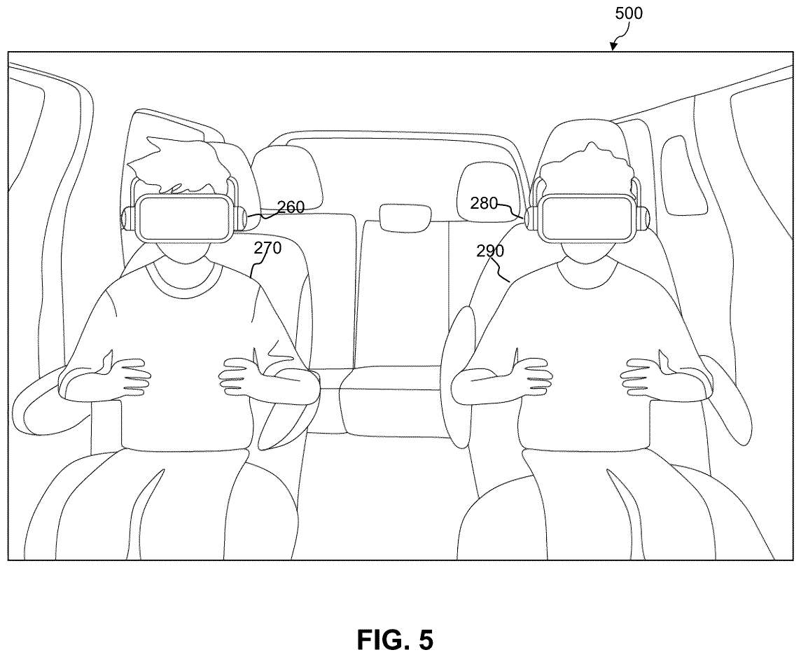

Referring now to FIG. 5, an internal vehicle environment 500 comprising user 270 and user 290 donning computing device 260 and computing device 280 respectively, according to an exemplary embodiment. It should be noted that a first visualization may be presented to computing device 260 and a second visualization may be presented to computing device 280, in which the first visualization may be rendered based on the applicable user profile associated with user 270 and the second visualization may be rendered based on the applicable user profile associated with user 290. In some embodiments, the first and second visualizations may be modified and/or optimized based on a feedback loop derived from data collected by computing device 260 and computing device 280. Furthermore, the feedback loop may account for analytics, preferences, and dislikes of user 270 and user 290. In this example, users 270 and 290 are passengers in the applicable vehicle, in which their attention is not necessary regarding the operation of the car. As a result, a first visualization is presented to computing device 260 and a second visualization is presented to computing device 280, each of the aforementioned visualization customized and tailored to the users based on analyses of the respective user profiles. In some embodiments, the first and second visualizations are generated based on one or more of the vehicle parameters, contextual information, user profiles, and the like. For example, the vehicle may be about to pass an obstacle during its route in which the first and second visualizations are rendered in a manner that masks the applicable obstacle from users 270 and 290. In some embodiments, the first and second visualizations are associated with each other allowing users 270 and 290 to interact with each other via a gaming experience, virtual whiteboard, telecommunication session, social media-based collaboration session, and any other applicable collaborative virtual sessions known to those of ordinary skill in the art.

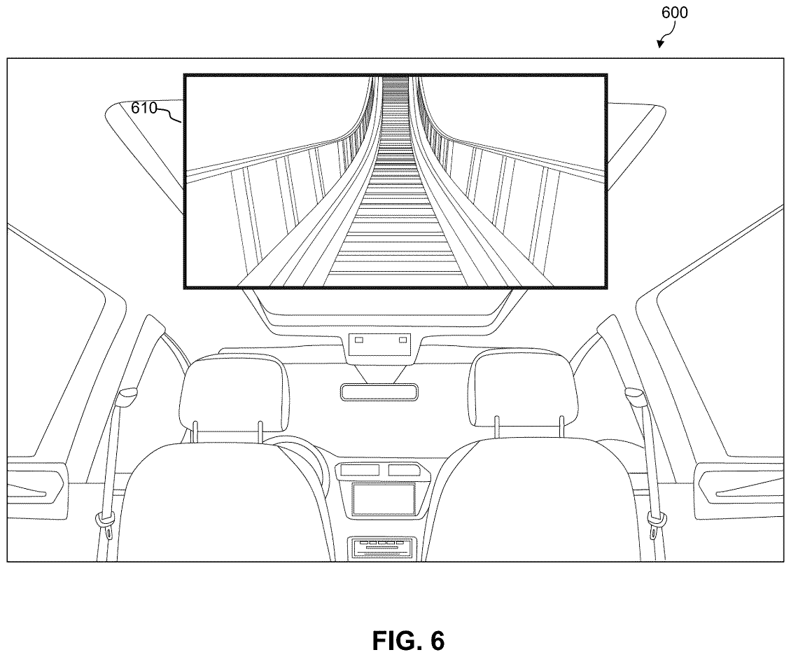

Referring now to FIG. 6, a first vehicular experience 600 comprising a first visualization 610 is illustrated, according to an exemplary embodiment. As depicted, the first visualization 610 is a virtual environment simulating a rollercoaster experience configured to integrate the vehicle into the virtual environment based on the potential pothole detected along the projected route associated with vehicle. In this example, user 270 is viewing first visualization 610 based on the system ascertaining from the applicable user profile associated with user 270 that they enjoy amusement park rides.

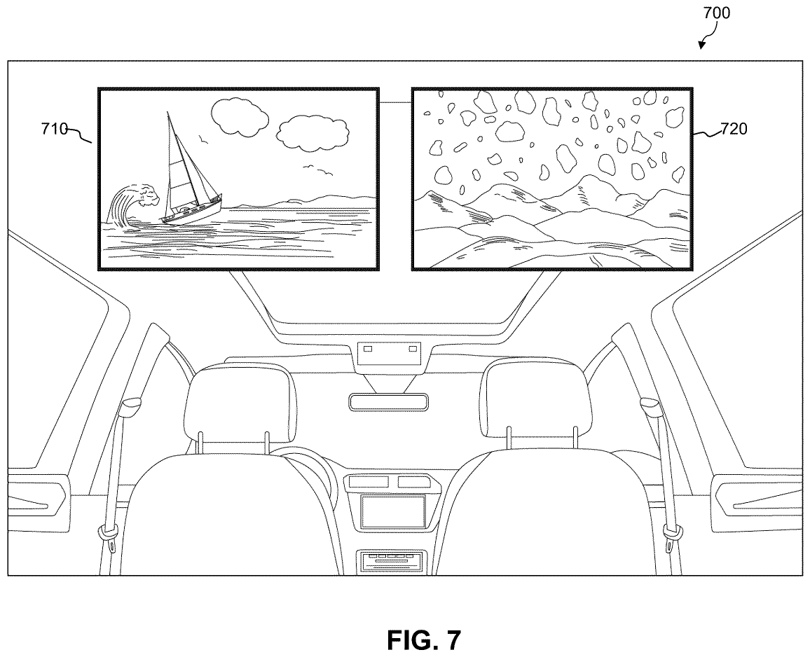

Referring now to FIG. 7, a second vehicular experience 700 comprising a second visualization 710 and a third visualization 720 is illustrated, according to an exemplary embodiment. As depicted, the second visualization 710 is a virtual environment simulating a tumultuous sea based on the predicted traffic associated with a route the vehicle is predicted to traverse. The third visualization 720 is a virtual environment simulating a meteor field in which the vehicle is integrated into the virtual environment as a spaceship based on predicted weather associated with a predicted route that the vehicle will traverse. In this example, second visualization 710 and third visualization 720 are rendered based on correlations between vehicle parameters or road conditions and the respective user profiles resulting in interactive virtual objects being overlaid on obstacles (e.g., traffic, construction, potholes, etc.) detected outside of the vehicle. In some embodiments, second visualization 710 and third visualization 720 function as optimized driving training simulations for an autonomous vehicle allowing users 270 and 290 to learn how to address various driving scenarios so that when the actual driving scenarios occur, users 270 will be prepared to operate the vehicle safely when it is not in an autonomous mode.

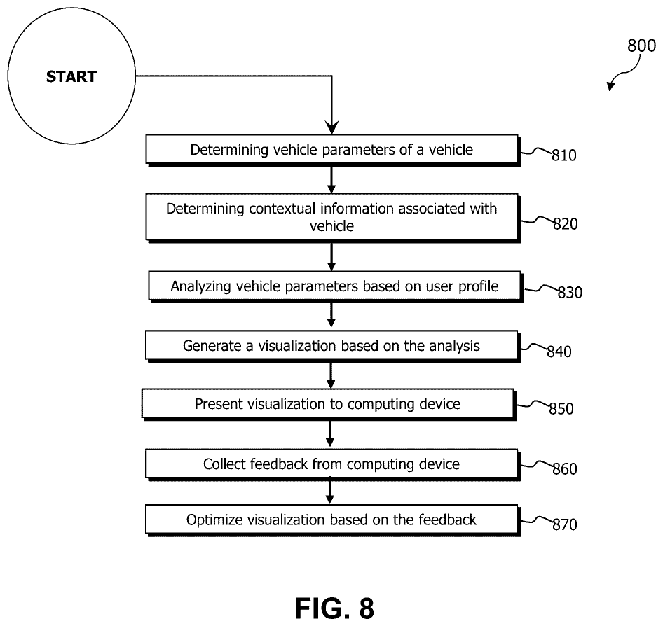

With the foregoing overview of the example architecture, it may be helpful now to consider a high-level discussion of an example process. FIG. 8 depicts a flowchart illustrating a computer-implemented process 800 for managing a vehicle identity, consistent with an illustrative embodiment. Process 800 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 810 of process 800, vehicle parameters module 310 collects sensor data and other applicable information associated with the applicable vehicle (e.g., predicted traffic, predicted obstacles, predicted landmarks, etc.). In some embodiments, vehicle parameters module 310 collects the various sensor data in order to ascertain external and/or internal parameters associated with the vehicle in addition to vehicle experience module 220 receiving third party data from external data sources such as, but not limited to weather sources, social media-based sources, news sources, and the like. In some embodiments, sensor data is collected from external systems vehicle parameters module 310 is configured to be in communication with including, but not limited to computer vision systems, security systems, closed-circuit television systems (CCTV), and any other applicable systems designed to capture media associated with vehicles known to those of ordinary skill in the art.

At step 820 of process 800, contextual module 330 determines contextual information associated with the vehicle. It should be noted that contextual information may be derived from analyses performed on vehicle parameters, user profiles, third party data, and the like. For example, it may be determined that the applicable vehicle is in a current operation mode based on various factors such as, but not limited to the vehicle operator viewing a rendered visualization, lack of user interaction with the steering wheel, eye gazing/monitoring analytics, etc. Contextual information may also account for moods/sentiments associated with users 270 and 290 based on sensor data collected by computing devices 260 and 280 subsequent to users opting into to biological data being collected and analyzed by the system.

At step 830 of process 800, vehicle experience module 220 analyzes vehicle parameters based on the applicable user profiles. The analyses of vehicle parameters comprises correlating the vehicle parameters to virtual elements for the visualizations based on ascertaining information from the user profiles for the purpose of updating virtual environment visualizations based on the correlations. For example, it may be ascertained from analyses of a user profile that user 270 does not like when the temperature is above a threshold amount resulting in a visualization being rendered comprising animations depicting the vehicle parameter of the internal temperature of the vehicle and real-time remedying of the vehicle parameter in order to align with the preferences of user 270 (e.g., snow beginning to fall in a hot desert, etc.). Analyzing the vehicle parameters based on the user profiles, contextual information, and the like is imperative to the rendering of visualizations because it may determine the theme, visual effects, virtual objects, etc. associated with the generated virtual environment depicted to user 270.

At step 840 of process 800, visualization rendering module 380 generates a visualization based on the aforementioned. In some embodiments, the visualizations are augmented virtual environments configured to integrate the applicable vehicle and its parameters into given virtual environments in order to provide an immersive experience for the viewer. Generative Adversarial Networks (GANs) and the like are utilized to render the high-resolution visualizations, in which the GANs are trained to generate artificial virtual objects in a simulated environment from media content of the real-world associated with the vehicle. One of the many goals of visualization rendering module 380 is to create more excellent sensible virtual environments comprising synthetic interactive virtual elements/objects that blend seamlessly into a virtual environment that support real-time modifications.

At step 850 of process 800, the generated visualization are presented to the applicable computing devices. As previously mentioned, user 270 may be experiencing a first visualization that aligns with their user profile while user 290 may be experiencing a second visualization that aligns with their respective user profile, in which the first and second visualizations may be distinct from each other. In some embodiments, the first and second visualizations are associated with each other resulting in a collaborative experience for users 270 and 290.

At step 860 of process 800, feedback module 360 collects feedback from users 270 and 290. The feedback collection process performed by feedback module 360 may be accomplished in a variety of manners including, but not limited analyses of contextual information, analyses of user reactions to visualizations ascertained by the applicable computing devices, linguistic processing of user statements associated with visualizations (e.g., user 270 uttering that the virtual objects are too bright, etc.), and the like. It is a goal of feedback module 360 to operate a feedback loop in order to optimize subsequently generated visualizations that are narrowly tailored to users 270 and 290 based on both the feedback and the user profiles.

At step 870 of process 800, visualization rendering module 380 optimizes the visualizations based on the ascertained feedback. The modifications of visualizations based on the feedback results in predictions generated by machine learning module 350 derived from vehicle parameters, contextual information, etc. to being manifested in a metaverse environment integrating the applicable vehicle. Users 270 and 290 have the ability to select themes, interactive virtual objects, relevant vehicle parameters and the like to be depicted within virtual environments ultimately improving the user experience within a vehicle.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for generating vehicular-based visualizations, the method comprising:
receiving, by a computing device, a plurality of vehicular parameters associated with a vehicle;
analyzing, by the computing device, the plurality of vehicular parameters based on a user profile associated with at least one occupant of the vehicle; and
generating, by the computing device, a virtual environment visualization associated with the vehicle based on the analysis.

2. The computer-implemented method of claim 1, wherein analyzing the plurality of vehicular parameters further comprises:
analyzing, by the computing device, a plurality of contextual information associated with the at least one occupant;
analyzing, by the computing device, a plurality of feedback information associated with the virtual environment visualization and the at least one occupant; and
updating, by the computing device, the user profile based on the plurality of feedback information.

3. The computer-implemented method of claim 1, wherein the virtual environment visualization is depicted to the at least one occupant via a computer-mediated reality device (CMR) communicatively coupled to at least one display of the vehicle.

4. The computer-implemented method of claim 1, wherein generating the virtual environment visualization comprises:
utilizing, by the computing device, one or more machine learning models to generate one or more predictions associated with a vehicular experience based on the plurality of vehicular parameters; and
integrating, by the computing device, a plurality of virtual elements derived from the one or more predictions into the virtual environment visualization.

5. The computer-implemented method of claim 4, further comprising:
correlating, by the computing device, the plurality of vehicular parameters with the plurality of virtual elements based on the user profile; and
updating, by the computing device, the virtual environment visualization based on the correlation.

6. The computer-implemented method of claim 1, wherein the virtual environment visualization comprises one or more interactive virtual objects configured to receive at least one input from the user.

7. The computer-implemented method of claim 1, wherein generating the virtual environment visualization comprises:
integrating, by the computing device, the vehicle and a subset of the plurality of vehicle parameters into the virtual environment visualization; and
updating, by the computing device, the virtual environment visualization based on the user profile.

8. A computer program product for generating vehicular-based visualizations, the computer program product comprising or more computer readable storage media and program instructions collectively stored on the one or more computer readable storage media, the stored program instructions comprising:
program instructions to receive a plurality of vehicular parameters associated with a vehicle;
program instructions to analyze the plurality of vehicular parameters based on a user profile associated with at least one occupant of the vehicle; and
program instructions to generate a virtual environment visualization associated with the vehicle based on the analysis.

9. The computer program product of claim 8, wherein program instructions to analyze the plurality of vehicular parameters further comprise:
program instructions to analyze a plurality of contextual information associated with the at least one occupant;
program instructions to analyze a plurality of feedback information associated with the virtual environment visualization and the at least one occupant; and
program instructions to update the user profile based on the plurality of feedback information.

10. The computer program product of claim 8, wherein the virtual environment visualization is depicted to the at least one occupant via a computer-mediated reality device (CMR) communicatively coupled to at least one display of the vehicle.

11. The computer program product of claim 8, wherein program instructions to generate the virtual environment visualization comprise:
program instruction to utilize one or more machine learning models to generate one or more predictions associated with a vehicular experience based on the plurality of vehicular parameters; and
program instructions to integrate a plurality of virtual elements derived from the one or more predictions into the virtual environment visualization.

12. The computer program product of claim 11, further comprising:
program instructions to correlate the plurality of vehicular parameters with the plurality of virtual elements based on the user profile; and
program instructions to update the virtual environment visualization based on the correlation.

13. The computer program product of claim 8, wherein the virtual environment visualization comprises one or more interactive virtual objects configured to receive at least one input from the user.

14. The computer program product of claim 8, wherein program instructions to generate the virtual environment visualization comprise:
program instructions to integrate the vehicle and a subset of the plurality of vehicle parameters into the virtual environment visualization; and
program instructions to update the virtual environment visualization based on the user profile.

15. A computer system for generating vehicular-based visualizations, the computer system comprising:
one or more processors;
one or more computer-readable memories;
program instructions stored on at least one of the one or more computer-readable memories for execution by at least one of the one or more processors, the program instructions comprising:
program instructions to receive a plurality of vehicular parameters associated with a vehicle;
program instructions to analyze the plurality of vehicular parameters based on a user profile associated with at least one occupant of the vehicle; and
program instructions to generate a virtual environment visualization associated with the vehicle based on the analysis.

16. The computer system of claim 15, wherein program instructions to analyze the plurality of vehicular parameters further comprise:
program instructions to analyze a plurality of contextual information associated with the at least one occupant;
program instructions to analyze a plurality of feedback information associated with the virtual environment visualization and the at least one occupant; and
program instructions to update the user profile based on the plurality of feedback information.

17. The computer system of claim 15, wherein program instructions to generate the virtual environment visualization comprise:
program instruction to utilize one or more machine learning models to generate one or more predictions associated with a vehicular experience based on the plurality of vehicular parameters; and
program instructions to integrate a plurality of virtual elements derived from the one or more predictions into the virtual environment visualization.

18. The computer system of claim 17, further comprising:
program instructions to correlate the plurality of vehicular parameters with the plurality of virtual elements based on the user profile; and
program instructions to update the virtual environment visualization based on the correlation.

19. The computer system of claim 15, wherein the virtual environment visualization comprises one or more interactive virtual objects configured to receive at least one input from the user.

20. The computer system of claim 15, wherein program instructions to generate the virtual environment visualization comprise:
program instructions to integrate the vehicle and a subset of the plurality of vehicle parameters into the virtual environment visualization; and
program instructions to update the virtual environment visualization based on the user profile.
